(19) United States
(12) Patent Application Publication
(10) Pub. No.: US 2026/0244162 A1
(43) Pub. Date: Aug. 20, 2026

(54) Wrist Watch Case Cleaning Apparatus

(71) Applicant: Gregory Presson, Schwenksville, PA (US)

(72) Inventor: Gregory Presson, Schwenksville, PA (US)

(21) Appl. No.: 19/114,640

(22) PCT Filed: Oct. 5, 2023
(86) PCT No.: PCT/US23/76058

§ 371 Date: Mar. 24, 2025

(51) Int. Cl. G04D 3/08

(52) U.S. Cl. CPC G04D 3/083

(57) ABSTRACT

A cleaning apparatus for a wrist watch comprising a chamber into which a wrist watch (including the case lugs) may be inserted, while leaving the attached watch strap mostly outside the chamber, a fluid inside the chamber, and an oleophilic low-abrasion particulate medium which is agitated by mechanical means to bring the particulate medium into contact with the metal surface of the watch case to clean surface contaminants therefrom.

This application claims priority from Patent Cooperation Treaty application PCT/US23/76058, filed Oct. 5, 2023, which claims priority from U.S. Provisional Patent Application 63/378,522 filed Oct. 6, 2022.

### BACKGROUND OF THE INVENTION

Luxury wrist watches are very often encased in precious metal cases that are somewhat prone to scratching/marring due to the relative softness of the metals used (18k Gold or Platinum) especially when removing the strap (for replacement or for cleaning the case/head). When worn, skin oils and other environmental contaminants are deposited on the watch case, and these, in turn, attract other surface contaminants which, if left on the case, dull its appearance and further degrade the metal surface finish. Ideally, such wrist watches should be carefully cleaned of contaminants after each wearing, before being put away in a storage case or watch winder. In practice, however, most owners of these watches are limited to wiping the watch down with a soft cloth, which is completely ineffective at getting to the inside of the lugs where the oil and grit collects. The only way to thoroughly clean the watch case/head is to remove the strap which is accomplished by jamming a metal spring bar tool between the strap and the inside of the lug and prying out the metal spring bar. This process results in scratching/gouging of the soft metal lugs with the spring bar tool and the spring bar itself during both the removal and re-installation processes. There is thus a need for a simple, automatic method of adequately cleaning environmental contaminants from the metal case of such wrist watches (and other jewelry) without removing the strap.

### BRIEF DESCRIPTION OF THE INVENTION

According to the preferred embodiment of the present invention, there is provided a chamber into which a wrist watch (including the case lugs) may be inserted, while leaving the attached watch strap mostly outside the chamber. After sealing the chamber, the fluid inside (which may be air, a dry gas such as nitrogen or carbon dioxide, or a liquid, such as a high vapor pressure fluorinated hydrocarbon,) and an oleophilic low-abrasion particulate medium is agitated by mechanical means (such as a pump, fan, ultrasonic transducer or the like) to bring the particulate medium into contact with the metal surface of the watch case. In this manner, surface contaminants including skin oils are transferred to the particulate medium by absorption and/or adsorption, and to the fluid by dissolution, frictional dislodgement and suspension, or similar mechanisms of action. After a suitable period of agitation, the chamber is unsealed, the watch removed, and optionally further polished in a conventional manner, if desired.

### BRIEF DESCRIPTION OF THE FIGURE

FIG. 1 depicts a preferred embodiment of the present invention in perspective view.

### DETAILED DESCRIPTION OF THE INVENTION

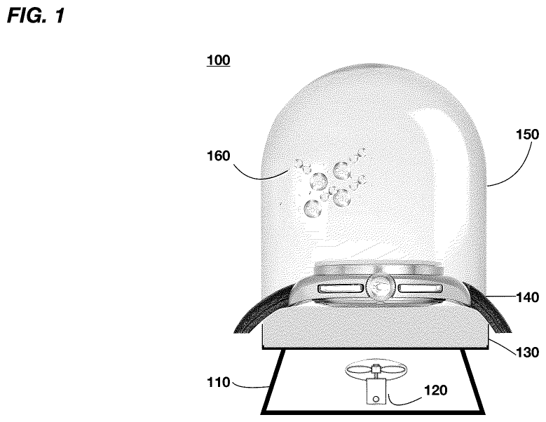

Referring now to FIG. 1 there is shown in cross-section a preferred embodiment of the present invention in perspective view. Watch cleaner 100 is comprised of base 110 and chamber enclosure 150, each of which is provided with a sealing apparatus 130 at the circumference where they contact each other. The sealing apparatus 130 may be any suitable seal for containing a fluid to be contained within the chamber defined by base 110 and chamber enclosure 150, such as a flexible elastomeric seal, polished mating surfaces, or the like. Disposed within base 110 and in fluid communication with the chamber is agitator 120. Agitator 120 may be any suitable device for causing circulation and turbulent flow of a fluid contained in the chamber. For instance, if the fluid is air, dry carbon dioxide, dry nitrogen, or a similar gas) a fan or venturi may be used as the agitator. If the fluid is a liquid (for example, distilled water, a fluorinated hydrocarbon, or supercritical carbon dioxide) then a pump may be used to agitate the fluid. Of course, the agitator may be provided with a flow of fluid internally to base 110, or externally, in a separate unit.

According to a preferred embodiment, an elastomeric seal is used to permit the straps attached to case lugs of watch 140 to protrude outside the chamber, so as to minimize contact between the straps and the fluid and particulate medium 160 inside the chamber. Alternatively, a custom-formed peripheral surface may be employed to perform the same function, or the straps or band may be protected using a temporary sleeve or coating.

According to the preferred embodiment, an oleophilic low-abrasion particulate medium 160 is disposed within the chamber prior to sealing the chamber. Preferably, this medium is a cellulosic microfiber having low abrasion characteristics, and high affinity for non-polar molecules, as well as high surface area to volume ratio. One source of such material is cotton fabric manufacturing “dust” or “lint”, and in particular, unbleached, undyed very short cotton fibers that are typically filtered from the air during the manufacture of cotton yarn. Alternatively, other natural cellulosic fibers that are low in abrasives such as ash and lignin may be employed. Another alternative is synthetic cellulosic fibers, such as rayon or viscose, which may be suitable because the abrasive nature of the fiber may be controlled during manufacture. If desired, a specialized modified cotton may be prepared to be superoleophilic, according to the method of Liping Liang, Yanyan Dong, Wang Xu & Xu Meng (2021) “Fabrication of hydrophobic/oleophilic cotton fabric based on thiol-ene click reaction for oil/water separation”, The Journal of The Textile Institute, DOI: 10.1080/00405000.2021.1952805.

In one embodiment, a cycle timer (not shown) is provided for energizing agitator 120 of the present invention, to provide adequate contact between the particulate medium 160 and the watch 140 case. In yet another embodiment, an optical sensor is employed to monitor the surface of the watch case. By observing the reflection of an image from the metal surface, the reduction of contaminants during agitation may be determined, and the agitation ceased as soon as appropriate.

### EXAMPLE

A Patek Philippe Calatrava 5227J having a yellow gold case and shiny alligator strap was worn for a day, and accumulated a visible coating of contaminants on its case. A watch case cleaning apparatus of the present invention was charged with 5 g of cotton fiber particulate medium, and the watch case placed in the chamber with the straps protruding from the seal. The chamber was sealed, and the agitator switched on for a period of 60 seconds. After allowing the particulate medium to settle, the apparatus was gently agitated to shake the particulate medium into the base. The chamber was opened, and the watch removed. The watch case was visibly free of contaminants. It was gently dusted with a clean, dry, lint free cotton cloth, and was observed to have a clean, mirror-like finish on the gold elements, and no visible contaminants on the watch crystal.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventor further requires that the scope accorded his claims be in accordance with the broadest possible construction available under the law as it exists on the date of filing hereof (and of the application from which this application obtains priority, if any) and that no narrowing of the scope of the appended claims be allowed due to subsequent changes in the law, as such a narrowing would constitute an ex post facto adjudication, and a taking without due process or just compensation.

I claim as my invention:

1. An apparatus for the non-abrasive removal of surface contaminants from a wrist watch case comprising:
a. A base having a void containing an agitator, a pedestal adapted to securely position a wrist watch case within the void, and a first peripheral sealing surface;
b. A chamber enclosure having a second peripheral sealing surface.

2. The apparatus of claim 1 wherein:
a. The pedestal is adapted to position a wrist watch case having an attached wrist strap within the void; and
b. Wherein the sealing surfaces conform to the wrist watch strap to allow the strap to be positioned across the sealing surfaces from the interior of the chamber to outside the chamber.

3. The apparatus of claim 1 further comprising:
a. An oleophilic low-abrasion particulate medium disposed within the base void and the chamber enclosure.

4. The apparatus of claim 2 further comprising:
a. An oleophilic low-abrasion particulate medium disposed within the base void and the chamber enclosure.
